(19) United States
(12) Patent Application Publication
(10) Pub. No.: US 2011/0142367 A1
(43) Pub. Date: Jun. 16, 2011

(54) METHODS AND SYSTEMS FOR CORRECTING IMAGE SCATTER

(76) Inventors: Charles William Stearns, Milwaukee, WI (US); Scott David Wollenweber, Waukesha, WI (US)

(21) Appl. No.: 12/638,472

(22) Filed: Dec. 15, 2009

(51) Int. Cl. G06K 9/40; G06F 17/18

(52) U.S. Cl. 382/275; 702/181

(57) ABSTRACT

Methods and systems for correcting image scatter are provided. The method includes generating an estimate of a detector activity, determining a probability that a scatter event has been counted as a true event using the estimate of a detector activity; generating a scatter correction estimate based on the determined probability, and applying the scatter correction estimate to an emission data set to generate an image of an object.

### BACKGROUND OF THE INVENTION

The subject matter disclosed herein relates generally to imaging systems, and more particularly, embodiments relate to systems and methods for correcting image scatter.

Positron Emission Tomography (PET) and Single Photon Emission Computed Tomography (SPECT) systems scan objects to acquire image information. During operation of a PET imaging system, for example, a patient is initially injected with a radiopharmaceutical that emits positrons as the radiopharmaceutical decays. The emitted positrons travel a relatively short distance before the positrons encounter an electron, at which point an annihilation event occurs whereby the electron and positron are annihilated and converted into two gamma photons each having an energy of 511 keV.

Scatter coincidence events occur when some gamma photons are deflected from their original direction due to interaction with a body part before reaching the detectors. It is desirable to reject the scatter events during the acquisition of emission sinograms, because the images generated using only the detected true coincidence events represent a true activity distribution of radio-activity in the scanned body part of the patient. Moreover, scattered radiations increase the background to the image, thus degrading the image contrast.

One conventional method to correct for scatter utilizes a model-based scatter estimation (MBSE) function. The MBSE function attempts to determine true counts received at each individual detector. The MBSE function represents a photon's detection probability as a function of incident photon energy. However, the conventional MBSE function to estimate scatter does not account for a detector photon pile-up condition. Detector photon pile-up occurs when two pulses arrive at the detector nearly at the same time. In this case, the signal of the second pulse is “piled up” on top of the signal from the first pulse. Pile-up may happen even at a low count rate, but the chance of pile-up increases as the count rate increases. When pulses arrive at a rate that exceeds the ability of the detector voltage output to decay back below a predetermined threshold between pulses, the two incoming pulses may be counted as a single pulse, namely a single true count.

Photon pile-up is count rate-dependent and results in a different measurement of scattered photons at different activity levels. As a result, the effects of photon pile-up may result in a less accurate scatter estimate.

### BRIEF DESCRIPTION OF THE INVENTION

In one embodiment, a method for correcting image scatter is provided. The method includes generating an estimate of detector activity, determining a probability that a scatter event has been counted as a true event using the estimate of a detector activity, generating a scatter correction estimate based on the determined probability, and applying the scatter correction estimate to an emission data set to generate an image of an object.

In another embodiment, a medical imaging system is provided. The medical imaging system includes a detector and a scatter estimate module coupled to the detector. The scatter estimate module is programmed to generate an estimate of detector activity, determine a probability that a scatter event has been counted as a true event using the estimate of a detector activity, generate a scatter correction estimate based on the determined probability, and apply the scatter correction estimate to an emission data set to generate an image of an object.

In a further embodiment, a computer readable medium encoded with a program is provided. The computer readable medium is programmed to instruct a computer to generate an estimate of detector activity, determine a probability that a scatter event has been counted as a true event using the estimate of a detector activity, generate a scatter correction estimate based on the determined probability, and apply the scatter correction estimate to an emission data set to generate an image of an object.

### BRIEF DESCRIPTION OF THE DRAWINGS

FIG. 1 is a simplified block diagram of an exemplary imaging system formed in accordance with various embodiments of the present invention.

FIG. 2 is a block diagram of an exemplary method for correcting scatter in accordance with various embodiments of the present invention.

FIG. 3 is a graphical illustration of a function that modifies the detector efficiency in accordance with various embodiments of the present invention.

FIG. 4 is a graphical illustration of exemplary results obtained in accordance with various embodiments of the present invention.

FIG. 5 is a pictorial view of an exemplary multi-modality imaging system formed in accordance with various embodiments of the present invention.

FIG. 6 is a block schematic diagram of the system illustrated in FIG. 5 formed in accordance with various embodiments of the present invention.

### DETAILED DESCRIPTION OF THE INVENTION

The foregoing summary, as well as the following detailed description of certain embodiments of the present invention, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block of random access memory, hard disk, or the like). Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Also as used herein, the phrase “reconstructing an image” is not intended to exclude embodiments of the present invention in which data representing an image is generated, but a viewable image is not. Therefore, as used herein the term “image” broadly refers to both viewable images and data representing a viewable image. However, many embodiments generate, or are configured to generate, at least one viewable image.

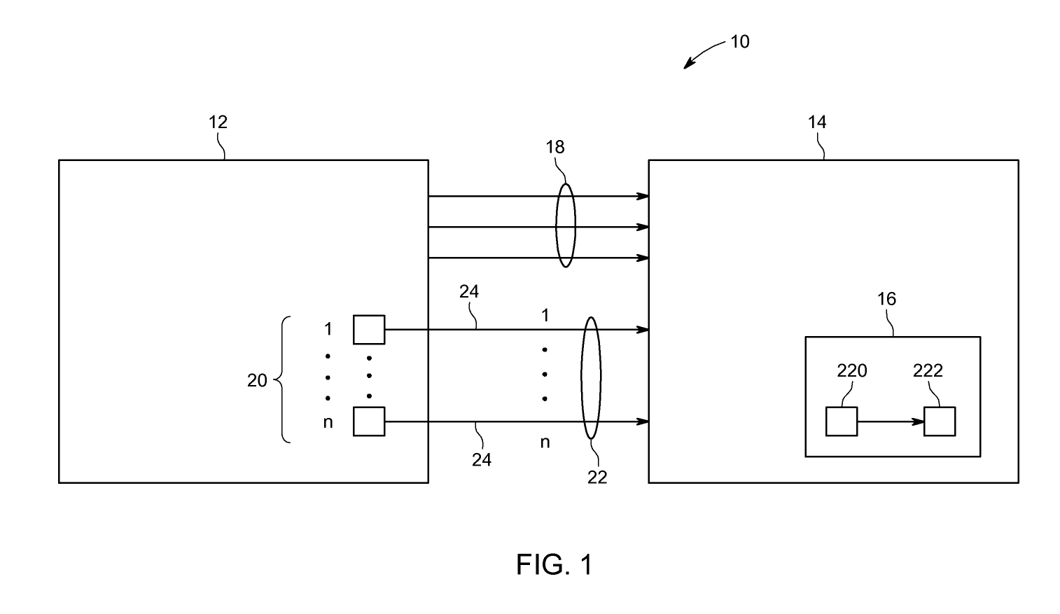

FIG. 1 is a schematic block diagram of an exemplary imaging system 10 formed in accordance with various embodiments described herein. In the exemplary embodiments, the imaging system 10 is a Positron Emission Tomography (PET) imaging system. Optionally, the imaging system 10 may be a Single Photon Emission Computed Tomography (SPECT) imaging system.

The imaging system 10 includes a detector 12 that is utilized to scan an object or patient. The imaging system 10 also includes a computer 14 and a scatter estimate module 16. As used herein, the term “computer” may include any processor-based or microprocessor-based system including systems using microcontrollers, reduced instruction set computers (RISC), application specific integrated circuits (ASICs), field programmable gate array (FPGAs), logic circuits, and any other circuit or processor capable of executing the functions described herein. The above examples are exemplary only, and are thus not intended to limit in any way the definition and/or meaning of the term “computer”. In the exemplary embodiment, the computer 14 executes a set of instructions that are stored in one or more storage elements or memories, in order to process input data. The storage elements may also store data or other information as desired or needed. The storage element may be in the form of an information source or a physical memory element within the computer 14.

In the exemplary embodiment, the scatter estimate module 16 is implemented as a set of instructions on the computer 14. The set of instructions may include various commands that instruct the computer 14 to perform specific operations such as the methods and processes of the various embodiments described herein. The set of instructions may be in the form of a software program. As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

The software may be in various forms such as system software or application software. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine.

Referring again to FIG. 1, the imaging system 10 also includes a communication link 18 that connects or communicates information from the detector 12 to the computer 14. The information may include for example, emission data generated by a plurality of detector elements 20 during a medical scanning procedure. The imaging system 10 also includes at least one communication link 22 that connects the detector 12 to the computer 14 and/or the scatter estimate module 16. In one exemplary embodiment, the imaging system 10 includes n detector elements 20 and n communication links 22. Optionally, the imaging system 10 includes n detector elements 20 and a single communication link 22 that transmits a plurality of detector busy signals 24 to the computer 14.

During operation, the output from the detector 12, referred to herein as a raw data set, is transmitted to the scatter estimate module 16 via the communication links 18. The scatter estimate module 16 is configured to utilize the raw data set to identify and remove scatter related imaging artifacts from the final reconstructed image set. The detector accumulates signal from an incoming photon during an interval of time on the order of several hundred nanoseconds, depending on the characteristics of the particular detector design. At the end of this period the detector compares the amount of signal received during the accumulation interval to a preset signal range, corresponding to a range of incoming photon energies near the energy of an unscattered annihilation photon. In one embodiment of a PET scanner this energy range is between 425 keV and 650 keV, allowing for a degree of imprecision in the measurement of the accumulated energy of a true 511 keV annihilation photon. In a PET scanner, detected photons with the appropriate energy signal are tested for time coincidence with photons detected by other detector units; when a coincidence is found, that coincidence event is placed in the raw data set.

Moreover, the communication link(s) 22 are configured to transmit a “detector busy signal” from each respective detector element 20 to the computer 14 and/or the scatter estimate module 16. A detector busy signal as used herein refers to a physical signal that indicates the fraction of time that the detector element is processing an event to determine if the event corresponds to a valid 511 keV photon. The detector busy signal value may be determined, for example, by interrogating the detection circuitry at a particular rate, and computing the fraction of responses indicating that the detector is engaged in the signal accumulation interval of an event processing cycle.

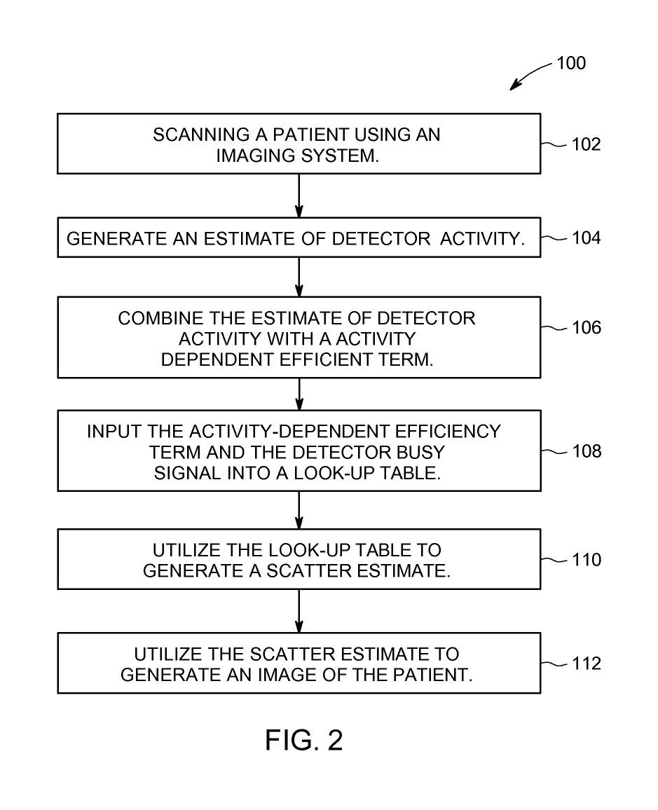

FIG. 2 is a block diagram of an exemplary method 100 of scatter correcting an emission data set. The method 100 may be performed by the scatter estimate module 16 shown in FIG. 1. The method 100 includes scanning a patient at 102 using an imaging system. In the exemplary embodiment, the patient is scanned using a medical imaging system, such as a Nuclear Medicine (NM) imaging system, for example the PET or SPECT imaging system described above.

At 104, an estimate of the detector activity is generated. In the exemplary embodiment, the detector busy signal 24 (shown in FIG. 1) is used to estimate the activity of the detector. For example, annihilation events are typically identified by a time coincidence between the detection of the two gamma photons in the two oppositely disposed detectors such that the gamma photon emissions are detected virtually simultaneously by each detector. More specifically, during an annihilation event, the electron and positron are converted into two gamma photons each having an energy of 511 keV. Annihilation events are typically identified by a time coincidence between the detection of the two 511 keV gamma photons in the two oppositely disposed detectors, i.e., the gamma photon emissions are detected virtually simultaneously by each detector. When two oppositely disposed gamma photons each strike an oppositely disposed detector to produce a time coincidence, gamma photons also identify a line of response (LOR), along which the annihilation event has occurred.

Some photons may be deflected from their original direction and such events are termed scatter events or scattered coincidences. It is desirable to reject the scatter events during the acquisition of emission sinograms, because images generated using only the detected true coincidence events represent a true activity distribution of radio-activity in the scanned body part of the patient. Not rejecting the scatter events in the image reconstruction results in biased estimates of the activity distribution in the patient. Scatter events may be discriminated from true events by the fact that one or both of the detected photons have an energy of less than 511 keV, having lost some of their energy in the scatter interaction. However, the measurement of photon energy by the detectors is imperfect, so that not all of the scatter events can be rejected on the basis of energy discrimination.

When there is a small amount of activity in the field of view of the scanner, e.g. the detector is less busy, photons arrive at the detector at a relatively low rate and it is unlikely that a second photon will arrive during the accumulation interval of a first photon. When the activity in the field of view is greater, e.g. the detector is busier, there is an increasing probability that a second photon will arrive during the accumulation interval. In many PET scanner designs this second photon is not recorded or processed, and is said to be lost due to system dead time. However, in addition to being lost, the second photon may interfere with the detection of the first photon. Some of the signal from the second photon is recorded in the accumulation interval of the first photon, unbeknownst to the detector processing electronics, so that the first photon is assumed to have the total signal of the first photon plus a fraction of the energy of the second photon. This total signal, rather than the signal of the first photon alone, is then tested against the energy range for unscattered photons. If the first photon is an unscattered photon, there is a probability that the total signal will exceed the upper limit to be considered a valid event; in this event the first photon is said to be lost to pile-up effects.

Consider instead, however, the instance where the first photon is a scattered photon which, measured alone, would be rejected by the energy range test. There is a probability that the additional signal from the second photon will be of the appropriate amount that the sum now passes the energy range test, and a scattered photon will be incorrectly accepted as a true event. This may be considered a gained event due to the pile-up effect. As the activity level is increased, the probability of true coincidence event detection is decreased and the probability of scattered coincidence event in increased, and therefore the ratio of detected scattered events relative to detected true events increases. Accordingly, in the exemplary embodiment, the scatter estimate module 16 is configured to utilize the detector busy signal to generate an activity-dependent estimation of scattered coincidence events, improving the quality of the scatter estimate, and, therefore, the quality of a reconstructed image. Optionally, the scatter estimate module 16 may estimate the detector activity at 104 by interrogating the detection circuitry at a particular rate, and computing the fraction of responses indicating that the detector is engaged in the signal accumulation interval of an event processing cycle.

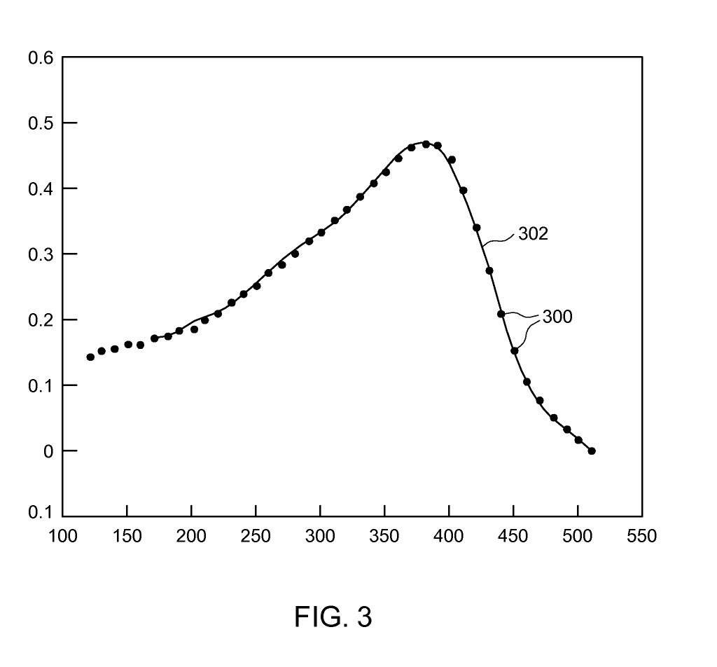

Referring again to FIG. 2, at 106, the estimate of detector activity determined at 104 is combined with an activity-dependent efficiency term γ(E). For example, FIG. 3 is a graphical illustration of a function that modifies the detector efficiency in accordance with various embodiments of the present invention. It should be realized that the exact shape of the curve depends on the specifics of the design of the detector subsystem for a particular scanner, and may be determined by Monte Carlo modeling or experiments using a detector assembly. The points 300 represent the rate of detector efficiency change, for example, the slope of the curves relative to the slope at 511 keV, as a function of photon energy, measured or calculated at several photon energy levels. The curve 302 represents a function chosen to provide an adequate representation of the efficiency change function for all energies in the range shown. In one embodiment, a tenth order polynomial is used as the function to represent the efficiency change function for all energies. This activity-dependent efficiency term γ(E) is used together with the measured detector busy signal DB to update the detector efficiency function through the equation:

D′_{eff}(E,θ)←D_{eff}(E,θ)+DB*γ(E),

where D_{eff}/E, θ) is a “base” look-up table, DB is the detector busy measurement signal 24, and γ(E) is the function depicted in this graph. In the exemplary embodiment, the activity-dependent efficiency term γ(E) is multiplied by the detector busy signal DB. Accordingly, when the detector is not busy, the value DB is approximately zero, and thus the revised detector efficiency value D′_{eff} is approximately equal to the D_{eff}. However, as the detector becomes busier, the value of the detector busy signal DB increases and thus the revised detector efficiency value D′_{eff} increases in proportion to the detector busy signal DB.

Referring again to FIG. 2, at 108, the activity-dependent efficiency term γ(E) and the detector busy signal DB are input to the base look-up table. For example, as shown in FIG. 2, in the exemplary embodiment, the revised detector efficiency value D′_{eff} term is used to replace the D_{eff}(E, θ) in the base LUT 220 to generate a revised look-up table (LUT) 222 that includes the detector activity-dependent efficiency term D′_{eff}(E, θ)+DB*γ(E). Accordingly, in the exemplary embodiment, at 108, a look-up table 222 (D′_{eff}(E, θ) is generated and/or a base-look up table (D_{eff}(E, θ)) 220 is revised to include the detector activity-dependent efficiency term DB*γ(E). In the exemplary embodiment, the LUT 222 includes the information from each detector element 20, the DB signal for that specific detector element, and the activity-dependent efficiency term γ(E). Moreover, it should be realized, that during operation, the LUT 222 may be continuously updated to include information generated by the detector elements 20 and the detector busy signal 24.

At 110, the information stored in the LUT 222 is utilized to generate a scatter estimate. In the exemplary embodiment, the LUT 222 may also include a “shape” term that is a function of energy. The shape term may be determined by simulation of the detector's performance. The LUT 222 may also include a “scaling” term, which is based on the detector busy signal itself. As a result, the LUT 222 represents the performance of the detectors at both very low activity levels and very high activity levels. Moreover, the LUT 222 may be progressively modified during the scanning procedure as the detector becomes more or less busy. In one embodiment, the LUT 222 may be modified for each detector element 20 in the detector 12 based on a composite of detector busy measurement signals 24. In another embodiment, the LUT 222 may be revised for each detector element 20 based on its individual detector busy measurement signals 24. At 112, the LUT 222 and other information are utilized to reconstruct an image of the patient.

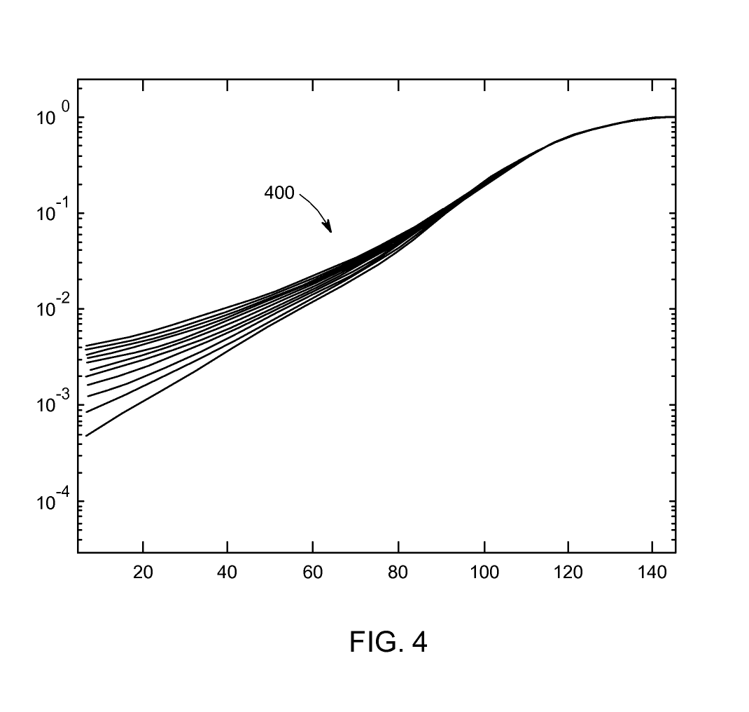

FIG. 4 is a graphical illustration of exemplary results obtained using the methods and system described herein. More specifically, FIG. 4 illustrates the scatter estimate in the portion of the raw data set from a source near the center of the field of view (not shown in the figure), with the detector busy signal 24 varying between 0 and 10% from the lowest curve to the highest curve.

A technical effect of at least some of the various embodiments is to provide a method and apparatus for performing scatter correction on a medical image. More specifically count rate information is used to generate an improved scatter estimate. The methods and systems described herein provide a scatter estimation that represents a photon's detection probability as a function of incident photon energy as part of the scatter calculation. The methods and systems also provide a photon detection probability function based on a system measurement of detector activity to improve the accuracy of the scatter estimate, and hence, the quality of the resulting reconstructed image. Therefore, inaccuracies in image reconstruction which result in errors in activity quantification, and, in the worst cases, to image artifacts, are reduced. The practice of the methods and systems described herein provide a scatter estimate model that better represents true system behavior, and therefore produces more accurate estimates of the scatter contamination of the acquired image data. The scatter estimate described herein results in an improved reconstructed image having higher image quality, fewer image artifacts, and improved quantitative accuracy.

Some embodiments of the present invention provide a machine-readable medium or media having instructions recorded thereon for a processor or computer to operate an imaging apparatus to perform an embodiment of a method described herein. The medium or media may be any type of CD-ROM, DVD, floppy disk, hard disk, optical disk, flash RAM drive, or other type of computer-readable medium or a combination thereof.

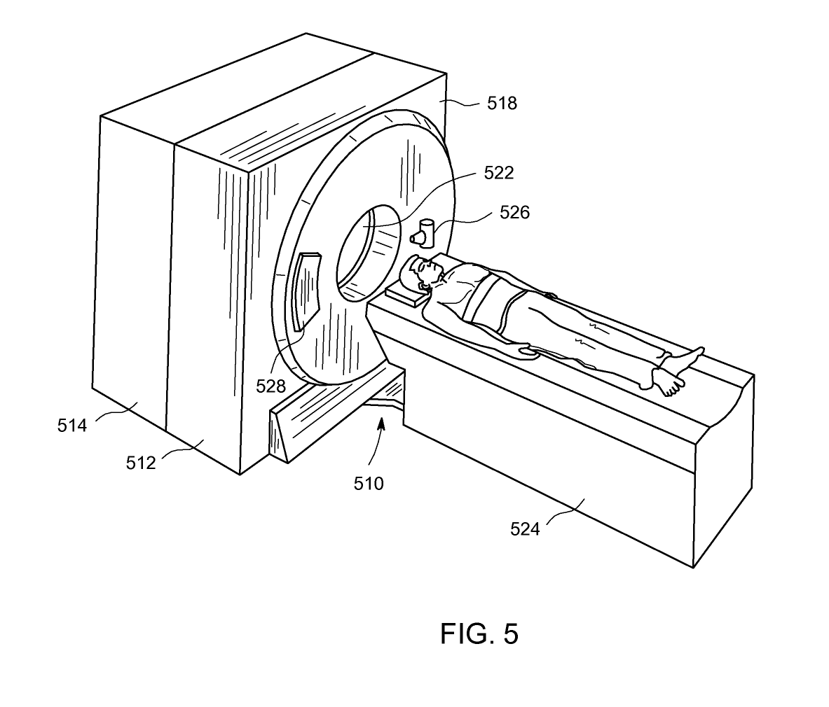

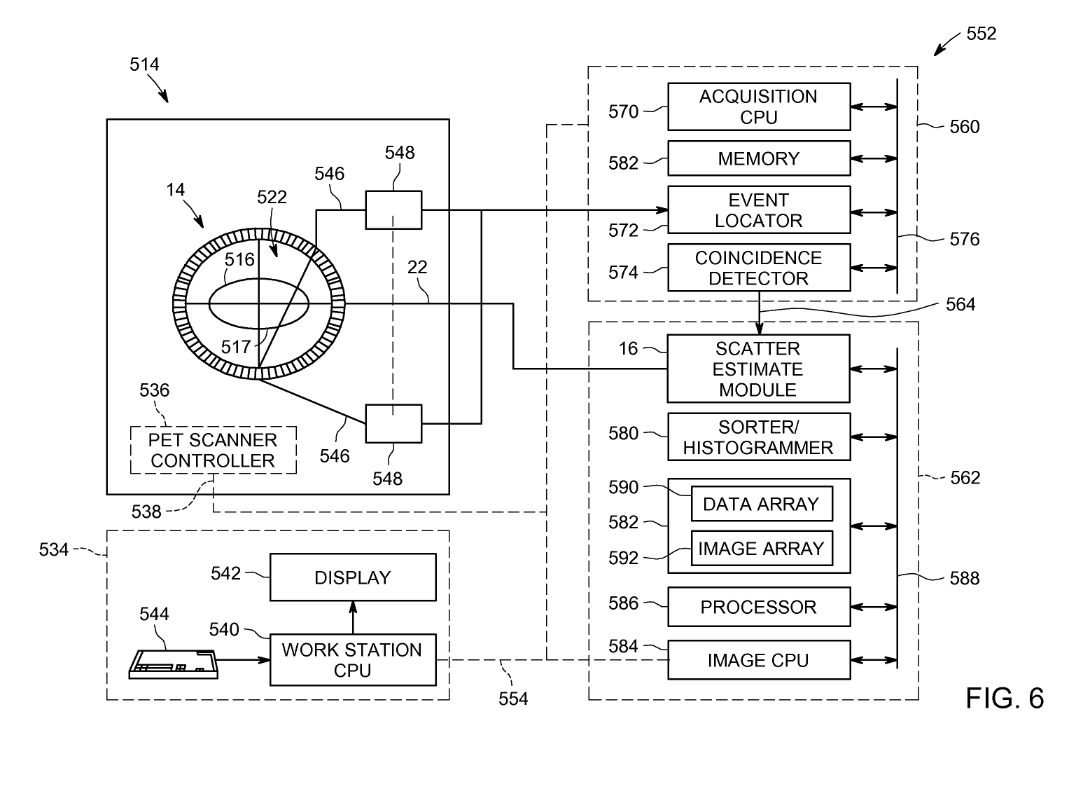

The scatter estimate module 16 may be utilized with an exemplary medical imaging system, such as the imaging system 510 shown in FIGS. 5 and 6. In the exemplary embodiment, the imaging system 510 is a multi-modality imaging system that includes different types of medical imaging systems, such as a Positron Emission Tomography (PET), a Single Photon Emission Computed Tomography (SPECT), a Computed Tomography (CT), an ultrasound system, Magnetic Resonance Imaging (MRI) or any other system capable or generating tomographic images. The scatter estimate module 16 described herein is not limited to multi-modality medical imaging systems, but may be used on a single modality medical imaging system such as a stand-alone PET imaging system or a stand-alone SPECT imaging system, for example. Moreover, the scatter estimate module 16 is not limited to medical imaging systems for imaging human subjects, but may include veterinary or non-medical systems for imaging non-human objects etc.

Referring to FIG. 5, the multi-modality imaging system 510 includes a first modality unit 512 and a second modality unit 514. The two modality units enable the multi-modality imaging system 510 to scan an object or patient, such as an object 516 in a first modality using the first modality unit 512 and to scan the object 516 in a second modality using the second modality unit 514. The multi-modality imaging system 510 allows for multiple scans in different modalities to facilitate an increased diagnostic capability over single modality systems. In one embodiment, first modality unit 512 is a Computed Tomography (CT) imaging system and the second modality 514 is a Positron Emission Tomography (PET) imaging system. The CT/PET system 510 is shown as including a gantry 518. During operation, the object 516 is positioned within a central opening 522, defined through the imaging system 510, using, for example, a motorized table 524. The gantry 518 includes an x-ray source 526 that projects a beam of x-rays toward a detector array 528 on the opposite side of the gantry 518.

FIG. 6 is a block schematic diagram of an exemplary PET imaging system 514 in accordance with an embodiment of the present invention. The PET imaging system 514 includes a detector ring assembly 12 including a plurality of detector scintillators. The detector ring assembly 12 includes the central opening 522, in which an object or patient, such as object 516 may be positioned, using, for example, a motorized table 524 (not shown in FIG. 5). The scanning operation is controlled from an operator workstation 534 through a PET scanner controller 536. A communication link 538 may be hardwired between the PET scanner controller 536 and the workstation 534. Optionally, the communication link 538 may be a wireless communication link that enables information to be transmitted to or from the workstation to the PET scanner controller 536 wirelessly. In the exemplary embodiment, the workstation 534 controls real-time operation of the PET imaging system 514. The workstation 534 may also be performed to perform the methods described herein. The operator workstation 534 includes a central processing unit (CPU) or computer 540, a display 542 and an input device 544. As used herein, the term “computer” may include any processor-based or microprocessor-based system configured to execute the methods described herein.

The methods described herein may be implemented as a set of instructions that include various commands that instruct the computer or processor 540 as a processing machine to perform specific operations such as the methods and processes of the various embodiments described herein. For example, the method 100 may be implemented as a set of instructions in the form of a software program. As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

During operation, when a photon collides with a scintillator on the detector ring assembly 12, a set of acquisition circuits 548 receive these analog signals. The acquisition circuits 548 produce digital signals indicating the 3-dimensional (3D) location and total energy of each event. The acquisition circuits 548 also produce an event detection pulse, which indicates the time or moment the scintillation event occurred. The digital signals are transmitted through a communication link, for example, a cable, to a data acquisition controller 552 that communicates with the workstation 534 and PET scanner controller 536 via a communication link 554. In one embodiment, the data acquisition controller 552 includes a data acquisition processor 560 and an image reconstruction processor 562 that are interconnected via a communication link 564. During operation, the acquisition circuits 548 transmit the digital signals to the data acquisition processor 560. The data acquisition processor 560 then performs various image enhancing techniques on the digital signals and transmits the enhanced or corrected digital signals to the image reconstruction processor 562 as discussed in more detail below.

In the exemplary embodiment, the data acquisition processor 560 includes at least an acquisition CPU or computer 570. The data acquisition processor 560 also includes an event locator circuit 572 and a coincidence detector 574. The acquisition CPU 570 controls communications on a back-plane bus 576 and on the communication link 564. During operation, the data acquisition processor 560 periodically samples the digital signals produced by the acquisition circuits 548. The digital signals produced by the acquisition circuits 548 are transmitted to the event locator circuit 572. The event locator circuit 572 processes the information to identify each valid event and provide a set of digital numbers or values indicative of the identified event. For example, this information indicates when the event took place and the position of the scintillator that detected the event. Moreover, the event locator circuit 572 may also transmit information to the scatter estimate module 16. The scatter estimate module 16 then generates a probability that the detected pulses are scatter events and updates the scatter estimate as described herein. The events are also counted to form a record of the single channel events recorded by each detector element. An event data packet is communicated to the coincidence detector 574 through the back-plane bus 576.

The coincidence detector 574 receives the event data packets from the event locator circuit 572 and determines if any two of the detected events are in coincidence. Coincident event pairs are located and recorded as a coincidence data packets by the coincidence detector 574 and are communicated through the back-plane bus 576 to the scatter estimate module. The output from the coincidence detector 574 is referred to herein as an emission data set or raw image data. In one embodiment, the emission data set may be stored in a memory device that is located in the data acquisition processor 560. Optionally, the emission data set may be stored in the workstation 534. As shown in FIG. 6, the detector busy signal 24 is also transmitted to the scatter estimate module 16.

The scatter corrected image data set, e.g. the image data subset, is then transmitted from the scatter estimate module 16 to a sorter/histogrammer 580 to generate a data structure known as a histogram. Optionally, the scatter estimate module 16 may generate the histograms described herein. The image reconstruction processor 562 also includes a memory module 582, an image CPU 584, an array processor 586, and a communication bus 588. During operation, the sorter/histogrammer 580 performs the motion related histogramming described above to generate the events listed in the image data subset into 3D data. This 3D data, or sinograms, is organized in one exemplary embodiment as a data array 590. The data array 590 is stored in the memory module 582. The communication bus 588 is linked to the communication link 576 through the image CPU 584. The image CPU 584 controls communication through communication bus 588. The array processor 586 is also connected to the communication bus 588. The array processor 586 receives the data array 590 as an input and reconstructs images in the form of image arrays 592. Resulting image arrays 592 are then stored in the memory module 582. The images stored in the image array 592 are communicated by the image CPU 584 to the operator workstation 534.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. For example, the ordering of steps recited in a method need not be performed in a particular order unless explicitly stated or implicitly required (e.g., one step requires the results or a product of a previous step to be available). Many other embodiments will be apparent to those of skill in the art upon reviewing and understanding the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for correcting image scatter, said method comprising:
generating an estimate of a detector activity;
determining a probability that a scatter event has been counted as a true event using the estimate of detector activity;
generating a scatter correction estimate based on the determined probability; and
applying the scatter correction estimate to an emission data set to generate an image of an object.

2. A method in accordance with claim 1 further comprising using a detector busy signal to generate the estimate of the detector activity.

3. A method in accordance with claim 1 further comprising:
utilizing a detector busy signal to determine a detector pile-up condition; and
determining a probability of detecting a scatter event based on the detector pile-up condition.

4. A method in accordance with claim 1 further comprising:
inputting the estimate of detector activity into a look-up table; and
determining the probability of detecting a scatter event using the look-up table.

5. A method in accordance with claim 1 further comprising:
acquiring a detector busy signal directly from a detector; and
generating the estimate of detector activity using the acquired detector busy signal.

6. A method in accordance with claim 1 further comprising:
detecting a photon at a detector element; and
activating a detector busy signal based on the detected photon.

7. A method in accordance with claim 6 further comprising:
determining an energy level of the detected photon; and
deactivating the detector busy signal when the energy level of the detected photon is determined.

8. A method in accordance with claim 1 further comprising:
periodically sampling a detector busy signal; and
updating the scatter estimate based on the periodic sampling.

9. A method in accordance with claim 1 further comprising:
acquiring a detector a detector busy signal from each of a plurality of detector elements;
determining a probability of detecting a scatter event using the detector busy signals; and
generating a scatter correction estimate based on the determined probabilities.

10. A medical imaging system comprising a detector and a scatter estimate module coupled to the detector, wherein the scatter estimate module is programmed to:
generate an estimate of a detector activity;
determining a probability that a scatter event has been counted as a true event using the estimate of detector activity;
generate a scatter correction estimate based on the determined probability; and
apply the scatter correction estimate to an emission data set to generate an image of an object.

11. A medical imaging system in accordance with claim 10, wherein the scatter estimate module is further programmed to utilize a detector busy signal to generate the estimate of detector activity.

12. A medical imaging system in accordance with claim 10, wherein the scatter estimate module is further programmed to:
modify a look-up table based on the estimate of detector activity; and
generate the scatter correction estimate based on the look-up table.

13. A medical imaging system in accordance with claim 10, wherein the scatter estimate module is further programmed to determine shape characteristics of the received voltage level signal.

14. A medical imaging system in accordance with claim 10, wherein the scatter estimate module is further programmed to acquire at least one of an analog and a digital detector busy signal from a detector.

15. A medical imaging system in accordance with claim 10, wherein the scatter estimate module is further programmed to:
detect a photon at a detector element;
activate a detector busy signal based on the detected photon; and
deactivate the detector busy signal when an energy level of the detected photon is determined.

16. A medical imaging system in accordance with claim 10, wherein the scatter estimate module is further programmed to:
periodically sample a detector busy signal; and
update the estimate of detector activity based on the periodic sampling.

17. A medical imaging system in accordance with claim 10, wherein the scatter estimate module is further programmed to:
receive a detector busy signal from each of a plurality of detector elements; and
generate a scatter correction estimate based on the plurality of detector busy signals.

18. A computer readable medium encoded with a program to instruct a computer to:
generate an estimate of a detector activity;
determining a probability that a scatter event has been counted as a true event using the estimate of detector activity;
generate a scatter correction estimate based on the determined probability; and
apply the scatter correction estimate to an emission data set to generate an image of an object.

19. A computer readable medium in accordance with claim 18 wherein the program further instructs a computer to utilize a detector busy signal to generate the estimate of detector activity.

20. A computer readable medium in accordance with claim 18 wherein the program further instructs a computer to:
modify a look-up table based on the estimate of detector activity; and
generate the scatter correction estimate based on the look-up table.
